(19) United States
(12) Patent Application Publication
(10) Pub. No.: US 2014/0036856 A1
(43) Pub. Date: Feb. 6, 2014

(54) APPARATUS AND METHOD FOR TRANSCEIVING A CONTROL SIGNAL IN A COMMUNICATION SYSTEM

(71) Applicant: Dong Hyun Park, Seoul (KR)

(72) Inventor: Dong Hyun Park, Seoul (KR)

(21) Appl. No.: 14/112,852

(22) PCT Filed: Apr. 20, 2012
(86) PCT No.: PCT/KR2012/003095

§ 371 Date: Oct. 18, 2013

(30) Foreign Application Priority Data
Apr. 20, 2011 (KR) 10-2011-0036976

(51) Int. Cl. H04W 72/04

(52) U.S. Cl. CPC H04W 72/0413
USPC 370/329

(57) ABSTRACT

A method and an apparatus for transmitting a Hybrid Automatic Repeat Request (HARQ) Acknowledgement (ACK)/Negative Acknowledgment (NACK) signal and a scheduling request (SR) over an identical uplink subframe by a user equipment in a time division duplex (TDD) system in a carrier aggregation environment is disclosed. An example of a method for transmitting a HARQ ACK/NACK signal and an SR includes: receiving an allocation of a plurality of SR Physical Uplink Control Channel (PUCCH) resources; and transmitting a HARQ ACK/NACK signal using the plurality of SR PUCCH resources.

### CROSS-REFERENCE TO RELATED APPLICATIONS

This application is the National Stage Entry of International Application PCT/KR2012/003095, filed on Apr. 20, 2012, and claims priority from and the benefit of Korean Patent Application No. 10-2011-0036976, filed on Apr. 20, 2011, which is incorporated herein by reference for all purposes as if fully set forth herein.

### BACKGROUND

1.FIELD

The present invention relates to a communication system and more particularly, to an apparatus and a method for transceiving a control signal.

2. Discussion of the Background

A communication system generally uses one bandwidth in order to transmit data. For example, a 2^{nd} communication system uses a bandwidth of 200 KHz to 1.25 MHz and a 3^{rd} communication system uses a bandwidth of 5 MHz to 10 MHz. In order to support an increased transmission capacity, long term evolution (LTE) or IEEE 802.16m of a 3^{rd} generation partnership project (3GPP) has continuously increased its own bandwidth up to 20 MHz or more in recent years. It is necessary to extend the bandwidth in order to increase the transmission capacity, but it is not easy to allocate a frequency having a high bandwidth except for a partial region in the world.

Meanwhile, a transmission terminal and a reception terminal transmit and receive signals to and from each other. Herein, the transmission terminal and the reception terminal may be a user equipment or a base station. When the transmission terminal transmits a signal, the reception terminal transmits an acknowledgement (ACK) signal or a negative acknowledgment (NACK) signal for indicating whether to normally receive the signal to the transmission terminal. The transmission terminal transmits a new signal according to whether to receive the ACK or NACK or retransmits a previously transmitted signal according to a hybrid automatic repeat request (hereinafter, referred to as ‘HARQ’) technique. Herein, the HARQ technique may include a chase combining scheme or an incremental redundancy scheme.

On the other hand, the user equipment may request resource allocation to the base station in order to transmit an uplink signal. In the long term evolution (LTE), the user equipment transmits a scheduling request (SR) to the base station in order to request the resource allocation.

### SUMMARY

An object of the present invention is to provide a method for transmitting a HARQ ACK/NACK signal so as to retransmit the HARQ ACK/NACK signal and a scheduling request (SR) to only a PDSCH that cannot successfully receive the HARQ ACK/NACK signal and the scheduling request instead of retransmitting the HARQ ACK/NACK signal and the scheduling request to all PDSCHs at the time of transmitting the HARQ ACK/NACK signal and the scheduling request over an identical uplink subframe in a time division duplex (TDD) system in a carrier aggregation environment.

Another object of the present invention is to provide a method that can multiplex and transmit the HARQ ACK/NACK signal by transmitting the HARQ ACK/NACK signal with a plurality of SR PUCCH resources at the time of transmitting the HARQ ACK/NACK signal and the scheduling request over the identical uplink subframe.

Yet another object of the present invention is to provide a method that can multiplex and transmit the HARQ ACK/NACK signal by transmitting the HARQ ACK/NACK signal with not the SR PUCCH resource but an ACK/NACK resource at the time of transmitting the HARQ ACK/NACK signal and the scheduling request over the identical uplink subframe.

In accordance with an aspect of the present invention, there is provided a method in which a user equipment (UE) transmits hybrid automatic repeat request (HARQ) ACK/NACK (acknowledgement/negative acknowledgement) information and a scheduling request (SR), in a communication system under a carrier aggregation environment, including the steps of: receiving an allocation of a plurality of SR PUCCHs; and transmitting the HARQ ACK/NACK signal in the same uplink subframe as an uplink subframe at the time of transmitting the SR through the plurality of SR PUCCH resources.

In this case, the SR PUCCH resource may be allocated so that the number of bits transmittable by the plurality of SR PUCCH resources is the same as the number of bits of the HARQ ACK/NACK signal.

Further, the method may further the step of bundling according to the number of transmitted bits of the plurality of SR PUCCH resources when the number of bits of the HARQ ACK/NACK signal is more than the number of bits transmittable by the plurality of SR PUCCH resources, and the HARQ ACK/NACK signal bundled by the plurality of SR PUCCH resources may be transmitted through the step.

At least one of the plurality of SR PUCCH resources may be allocated through ack/nack resource indicator (ARI) or allocated through UE-specific higher layer signaling.

In accordance with another aspect of the present invention, there is provided a method in which a base station receives hybrid automatic repeat request (HARQ) ACK/NACK (acknowledgement/negative acknowledgement) information and a scheduling request (SR), in a communication system under a carrier aggregation environment, including the steps of: receiving an allocation of a plurality of physical uplink control channel (PUCCH) resources and SR PUCCH resources; and transmitting the HARQ ACK/NACK signal and transmitting the SR by the SR PUCCH resource in a channel selection situation using the plurality of ACK/NACK PUCCH resources, and the HARQ ACK/NACK signal and the SR are transmitted in the same uplink subframe.

In this case, when the number of bits of the HARQ ACK/NACK signal to be transmitted by the channel selection is between 2 bits and 4 bits, the plurality of ACK/NACK PUCCH resources may be allocated so as to transmit a signal having the same number of bits as the number of bits of the HARQ ACK/NACK signal to be transmitted.

In addition, the method may further include the step of creating the HARQ ACK/NACK signal bundled, which has the number of bits that is the same as the number of bits of the signal to be transmitted by the channel selection or less than the number of bits of the signal to be transmitted by the channel selection by bundling the HARQ ACK/NACK signal when the number of bits of the HARQ ACK/NACK signal is more than the number of bits of the signal to be transmitted by the channel selection, and in the transmitting step, the bundled HARQ ACK/NACK signal may be transmitted by using the channel selection.

In the present invention, a user equipment may receive an allocation of at least one SR physical uplink control channel (PUCCH) resource and transmit at least one PUCCH in the same uplink subframe as the uplink subframe at the time of transmitting the SR by using at least one SR PUCCH resource, and at least one PUCCH may transmit the HARQ ACK/NACK signals in the case of a positive SR.

In the present invention, a base station may transmit a control signal and data onto a physical downlink control channel (PDCCH) and a physical downlink data channel (PDSCH) and receive HARQ ACK/NACK signals for the control signal or the data, and at least one PUCCH may be a PUCCH using an SR PUCCH resource.

In accordance with yet another aspect of the present invention, there is provided a user equipment including: a transceiver transceiving information; and a controller transmitting hybrid automatic repeat request (HARQ) ACK/NACK (acknowledgement/negative acknowledgement) signals and a scheduling request (SR), and the controller may transmit at least one PUCCH in the same uplink subframe as an uplink subframe at the time of transmitting the SR by using at least one SR physical uplink control channel (PUCCH) resource, and the controller may transmit the HARQ ACK/NACK information on at least one PUCCH in the case of a positive SR.

In accordance with still another aspect of the present invention, there is a base station including: a transceiver transceiving information; and a controller receiving a hybrid automatic repeat request (HARQ) ACK/NACK (acknowledgement/negative acknowledgement) information and a scheduling request (SR), and the controller may receive HARQ ACK/NACK information for data transmitted to a downlink on at least one physical uplink control channel (PUCCH), and at least one PUCCH may be a PUCCH using an SR PUCCH resource.

According to the present invention, a HARQ ACK/NACK signal can be transmitted so as to retransmit the HARQ ACK/NACK signal and a scheduling request (SR) to only a PDSCH that cannot successfully receive the HARQ ACK/NACK signal and the scheduling request instead of retransmitting the HARQ ACK/NACK signal and the scheduling request to all PDSCHs at the time of transmitting the HARQ ACK/NACK signal and the scheduling request on the same uplink subframe in a time division duplex (TDD) system in a carrier aggregation environment.

According to the present invention, the HARQ ACK/NACK signal can be multiplexed and transmitted by transmitting the HARQ ACK/NACK signal with a plurality of SR PUCCH resources at the time of transmitting the HARQ ACK/NACK signal and the scheduling request over the identical uplink subframe.

According to the present invention, the HARQ ACK/NACK signal can be multiplexed and transmitted by transmitting the HARQ ACK/NACK signal transmitting the HARQ ACK/NACK signal with not the SR PUCCH resource but an ACK/NACK resource at the time of transmitting the HARQ ACK/NACK signal and the scheduling request over the identical uplink subframe.

### BRIEF DESCRIPTION OF THE DRAWINGS

FIG. 1 is a diagram schematically describing an SPS in 3GPP LTE.

FIG. 2 illustrates one example of an uplink subframe structure of carrying an ACK/NACK signal.

FIG. 3 illustrates one example of transmitting the ACK/NACK signal onto a PUCCH.

FIG. 4 illustrates an example mapping the PUCCH to physical RBs according to Equation 1.

FIG. 5 schematically illustrates time and frequency structures of an uplink/downlink in FDD and TDD modes.

FIG. 6 is a diagram schematically describing a positive SR situation in which a HARQ ACK/NACK signal is transmitted by using additionally allocated SR resources in a TDD system according to the present invention.

FIG. 7 is a diagram describing, as an example, a case in which 2 element carriers transmitted to the downlink transmit 2 codewords, respectively in a TDD CA environment under the positive SR situation in which the HARQ ACK/NACK is transmitted by additionally allocating the SR resource.

FIG. 8 is a flowchart schematically describing a method for transmitting an ACK/NACK signal by additionally allocating an SR resource in the case of a positive SR in a system according to the present invention.

FIG. 9 is a diagram schematically describing a positive SR situation in which a HARQ ACK/NACK signal is transmitted by using channel selection in a TDD system according to the present invention.

FIG. 10 is a diagram describing a case in which the HARQ ACK/NACK signal is transmitted in a PUCCH format 3 using channel selection with an ACK/NACK resource, a positive SR is transmitted with an SR resource, and 2 element carriers transmitted by a downlink transmit 2 codewords, respectively in a TDD CA environment.

FIG. 11 is a flowchart schematically describing a method for transmitting an ACK/NACK signal by using channel selection in the case of a positive SR in the system according to the present invention.

FIG. 12 is a block diagram schematically describing configurations of a user equipment and a base station in the system according to the present invention.

### DETAILED DESCRIPTION OF THE ILLUSTRATED EMBODIMENTS

Herein, some embodiments will be described in detail with reference to the accompanying drawings in the present specification. In the figures, even though the parts are illustrated in different drawings, it should be understood that like reference numbers refer to the same or equivalent parts of the present invention throughout the several figures of the drawing. In describing the embodiments of the present specification, when it is determined that the detailed description of the known art related to the present invention may obscure the gist of the present invention, the detailed description thereof will be omitted.

There is no limit in a multiple access technique applied to a wireless communication system. Various multiple access techniques may be used, such as code division multiple access (CDMA), time division multiple access (TDMA), frequency division multiple access (FDMA), orthogonal frequency division multiple access (OFDMA), single carrier-FDMA (SC-FDMA), OFDM-FDMA, OFDM-TDMA, and OFDM-CDMA. A time division duplex (TDD) technique in which transmission is performed by different times may be used or a frequency division duplex (FDD) technique in which transmission is performed by using different frequencies may be used, in uplink transmission and downlink transmission.

A scheduler of a base station (eNB) distributes usable radio resources in one cell between user equipments and between radio bearers of the respective user equipments. Principally, the base station allocates an uplink or downlink radio resource to each user equipment based on each of buffered downlink data and buffer status reports (BSR) received from the user equipment. During the processing, the base station considers a quality of service (QoS) request of each set radio bearer and selects a size of a medium access control (MAC) protocol data unit (PDU).

A general mode of scheduling as dynamic scheduling is performed by a downlink assignment message for allocation of a downlink transmission resource and an uplink grant message for allocation of an uplink transmission resource. The downlink assignment message and the uplink grant message are effective during a special single subframe. The downlink assignment message and the uplink grant message are transmitted onto a PDCCH by using a cell radio network temporary identifier (C-RNTI). The scheduling of this mode is effective for a service type such as a transmission control protocol (TCP) or a signaling radio bearer (SRB) when traffic is dynamic.

Semi-persistent scheduling (SPS) is defined in addition to the dynamic scheduling.

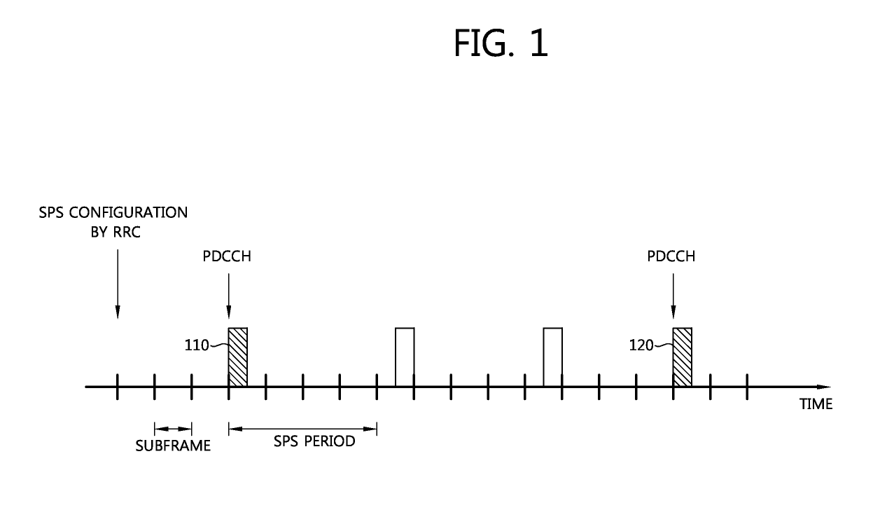

FIG. 1 illustrates the SPS in 3GPP LTE. This represents DL SPS, but UL SPS may also be similarly applied. Referring to FIG. 1, first, the base station sends SPS setting to the user equipment through an RRC message. In FIG. 1, a case in which an SPS period has four subframe periods will be described as an example.

The SPS does not a specific downlink assignment message or uplink grant message through the PDCCH of each subframe, and a radio resource is allocated to each subframe during a time period longer than one subframe and may be semi-statically set.

When the SPS is configured, the user equipment performs the SPS after the SPS is activated by a PDCCH 110 by monitoring the PDCCH 110 in which a cyclic redundancy check (CRC) is masked by the cell radio network temporary identifier (SPS-C-RNTI). In order to distinguish a scheduling message applied to continuous scheduling and a scheduling message applied to a dynamic scheduling message, an SPS-C-RNTI different from a C-RNTI used in the dynamic scheduling message may be used. Various fields included in downlink control information (DCI) on the PDCCH 110 may be used to activate and inactivate the SPS.

When the SPS is activated, the user equipment may receive a transmission block on the PDSCH during the SPS period in spite of not receiving a DL grant on the PDCCH. When the SPS is applied, downlink data transmission on the PDSCH is performed without a downlink grant on the PDCCH corresponding thereto and a physical uplink control channel (PUCCH) ACK/NACK resource index used by the user equipment is semi-statically set by higher layer signaling.

The CRC monitors a PDCCH 120 masked by the SPS-C-RNTI, and as a result, the user equipment may check the inactivation of the SPS.

Meanwhile, in association with uplink scheduling, when the user equipment is not sufficiently allocated with a UL_SCH resource required for reporting such as the buffer status report (BSR), or the like, the user equipment may transmit a scheduling request (SR) of a single bit through the PUCCH.

Carrier aggregation (hereinafter, referred to as ‘CA’) which supports a plurality of carriers may be called spectrum aggregation or bandwidth aggregation.

The number of aggregated carriers may be differently set between a downlink and an uplink, and sizes (that is, bandwidths) of element carriers may be different from each other. The respective element carriers may have control channels such as the PDCCH, and the like, and may be adjacent to each other or not adjacent to each other. The user equipment may support one or more carriers depending on its capacity.

The element carrier may be divided into a primary component carrier (PCC) and a secondary component carrier (SCC) depending on activation. The primary component carrier is a continuously activated carrier and the secondary component carrier is a carrier which is activated or deactivated according to a specific condition. The user equipment may use only primary component carrier or use one or more secondary component carriers in addition to the primary component carrier.

Hereinafter, a CA environment represents a system that supports multiple component carriers (carrier aggregation). Even in the CA environment, a physical layer may operate as time division duplex (TDD) and/or frequency division duplex (FDD).

Meanwhile, a user equipment that receives downlink data from the base station transmits an acknowledgement (ACK)/negative acknowledgement (NACK) response to the base station after a predetermined time elapses or at a predetermined timing. The downlink data may be transmitted onto the PDSCH indicated by the PDCCH. An ACK/NACK signal becomes ACK information when the downlink data is successfully decoded and NACK information when decoding the downlink data is failed. The base station may retransmit the downlink data at the maximum number of retransmission times when the NACK information is received. The base station may dynamically notify a transmission time of the ACK/NACK signal or resource allocation for the downlink data through signaling. Alternatively, the transmission time of the ACK/NACK signal or resource allocation may be set according to a transmission time of the downlink data or resource allocation.

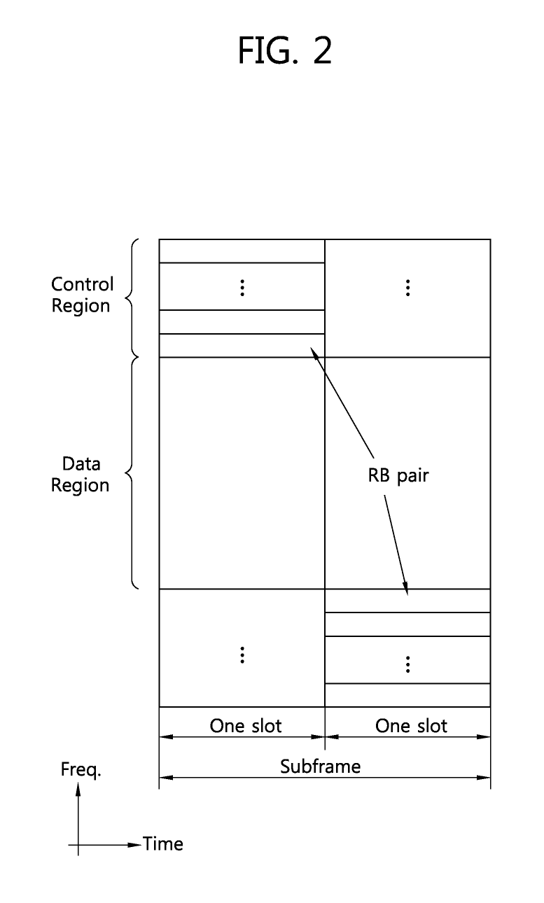

FIG. 2 illustrates one example of an uplink subframe structure of carrying an ACK/NACK signal.

Referring to FIG. 2, the uplink subframe may be divided into a control region to which the PUCCH for transporting uplink control information is allocated and a data region to which the PUSCH for transporting user data is allocated in a frequency domain.

The uplink control information transmitted on the PUCCH includes a scheduling request (SR) which is an uplink radio resource allocation request, acknowledgement (ACK)/negative acknowledgement (NACK) used to perform HARQ, and a channel quality indicator (CQI)/precoding matrix indicators (PMI)/a rank indicator (RI) which is channel information fed back with respect to previously performed downlink transmission. A sounding reference signal (SRS) which is a reference signal for scheduling the uplink transmission is transmitted in the PUSCH.

The PUCCH for one user equipment is allocated to a resource block (RB) pair in the subframe and the allocated resource block pair is resource blocks corresponding to subcarriers which are different in two respective slots. In this case, the resource block pair allocated to the PUCCH is frequency-hopped on a slot boundary.

The PUCCH may support multiple formats. That is, the uplink control information having different bits per subframe may be transmitted according to a modulation scheme. Table 1 below shows a modulation scheme and the number of bits depending on various PUCCH formats.

TABLE 1

| PUCCH | Modulation | Number of bits per |
|---|---|---|
| format | scheme | subframe, M_{bit} |
| 1 | N/A | N/A |
| 1a | BPSK | 1 |
| 1b | QPSK | 2 |
| 2 | QPSK | 20 |
| 2a | QPSK + BPSK | 21 |
| 2b | QPSK + QPSK | 22 |

PUCCH format 1 is used for transmitting the scheduling request (SR) and PUCCH format 1a/1b is used for transmitting a HARQ ACK/NACK signal. PUCCH format 2 is used for transmitting the CQI and PUCCH format 2a/2b is used for transmitting the CQI and the HARQ ACK/NACK. When the HARQ ACK/NACK signal is singly transmitted, PUCCH format 1a/1b is used and when the SR is singly transmitted, PUCCH format 1 is used.

Control information transmitted onto the PUCCH uses a cyclically shifted sequence. The cyclically shifted sequence is acquired by cyclically shifting a base sequence by a specific cyclic shift (CS) amount. When one resource block includes 12 subcarriers, a sequence having a length of 12 is used as the base sequence.

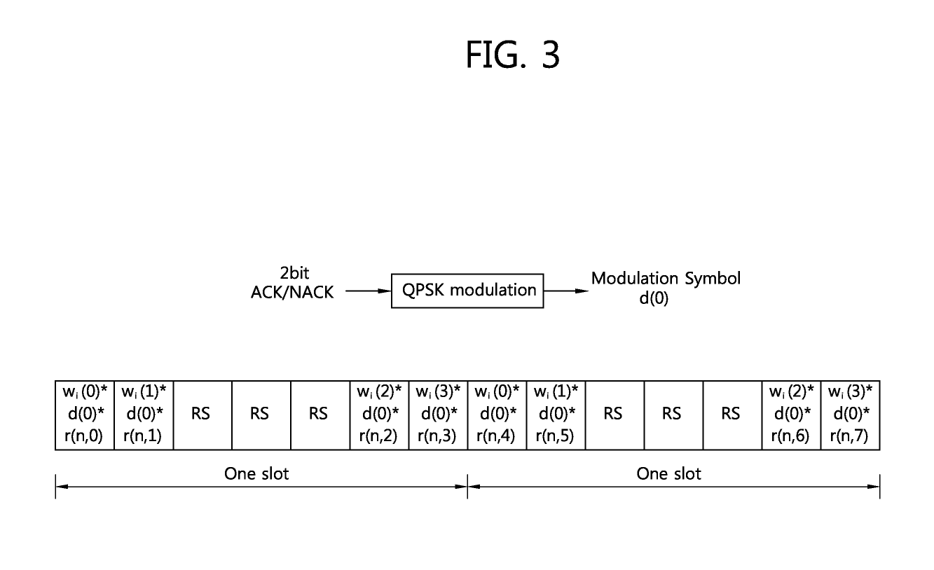

FIG. 3 illustrates one example of transmitting the ACK/NACK signal onto a PUCCH. In FIG. 3, as one example of the ACK/NACK signal transmission, the ACK/NACK signal transmission in a single carrier frequency division multiple access (SC-FDMA) scheme will be described.

Referring to FIG. 3, the reference signal (RS) is loaded on 3 SC-FDMA symbols among 7 SC-FDMA symbols included in one slot and the ACK/NACK signal is loaded on 4 remaining SC-FDMA symbols. The RS is loaded on three contiguous SC-FDMA symbols in each slot.

An ACK/NACK signal of 2 bits is quadrature phase shift keying (QPSK)-modulated to be created as one modulation symbol d(0) in order to transmit the ACK/NACK signal and a sequence y(n) modulated based the modulation signal d(0) and a cyclically shifted sequence r(n,a) may be created. Herein, n as a component index has a value of 0≦n≦N−1 with respect to a sequence length N. Further, a represents an amount of a cyclic shift (CS).

A value of the CS of the cyclically shifted sequence r(n,α) may be different or may be the same for each SC-FDMA symbol. In FIG. 3, herein, α, the CS values are sequentially, for example, 0, 1, 2, and 3 with respect to 4 SC-FDMA symbols in one slot, but the values are just examples.

Further, in FIG. 3, the ACK/NACK signal of 2 bits is QPSK-modulated to be created as one modulation symbol, but an ACK/NACK signal of 1 bit is binary phase shift keying (BPSK)-modulated to be created as one modulation symbol. The number of bits, a modulation scheme, and the number of modulation symbols of the ACK/NACK signal are just examples and do not limit the technical spirit of the present invention.

In addition, the modulated sequence may be again diffused by using an orthogonal sequence (OS) in order to increase the user equipment capacity.

In FIG. 3, a sequence modulated through w,(k) which is an orthogonal sequence a diffusion coefficient K is 4 is diffused with respect to 4 SC-FDMA symbols in one slot for the ACK/NACK signal. Herein, i represents a sequence index and 0≦k≦K−1.

The RS may be created based on a sequence created and cyclically shifted from the same base sequence as the ACK/NACK and the orthogonal sequence. That is, the cyclically shifted sequence is diffused through an orthogonal sequence wᵢ(k) in which the diffusion coefficient K is 3 to be used as the RS.

A resource index n⁽¹⁾_{PUCCH} which is a resource for transmitting PUCCH format 1/1a/1b is used to determine a CS value α(nₛ,1) of the base sequence and an orthogonal sequence index n_{OC}(nₛ) in addition to a physical resource block to which an A/N signal is transmitted. In addition, n⁽¹⁾_{PUCCH} which is the resource index for the HARQ ACK/NACK signal may be obtained as shown in Table 2 below. The resource index n⁽¹⁾_{PUCCH} is a parameter that determines a physical RB index n_{PRB}, the CS value of the base sequence α(nₛ,1), and the orthogonal sequence index n_{OC}(nₛ).

TABLE 2

| | Dynamic scheduling | Semi-persistent scheduling |
|---|---|---|
| Resource index | n⁽¹⁾_{PUCCH} = | Signaled by higher layer |
| | n_{CCE} + N⁽¹⁾_{PUCCH} | or a control channel |
| Higher Layer | N⁽¹⁾_{PUCCH} | n⁽¹⁾_{PUCCH} |
| Signaling value | | |

That is, according to Table 2, the HARQ ACK/NACK signal for the PDSCH transmitted in an n-th subframe is transmitted in an n+4-th subframe by using the resource index n⁽¹⁾_{PUCCH} which is the sum of a first control channel element (CCE) index N_{CCE} of the PDCCH transmitted in the n-th subframe and N⁽¹⁾_{PUCCH} which is a value obtained through higher layer signaling or a separate control channel. N⁽¹⁾_{PUCCH} is the total number of PUCCH format 1/1a/1b resources required for semi-persistent scheduling (SPS) transmission and scheduling request (SR) transmission. In the semi-persistent scheduling transmission and the SR transmission, since the PDCCH indicating the corresponding PDSCH transmission does not exist, the base station may explicitly notify n⁽¹⁾_{PUCCH} to the user equipment.

When the HARQ ACK/NACK signal and/or the SR are/is transmitted through the PUCCH format 1/1a/1b, the physical RB index n_{PRB} is determined by the resource index n⁽¹⁾_{PUCCH}. This is shown in Equation 1 below.

$$〈 Equation 1 〉$$

$$m = \{ \begin{matrix}{N}_{RB}^{2} & if {n}_{PUCCH}^{( 1 )} < c \cdot {N}_{cs}^{( 1 )} / {Δ}_{shift}^{PUCCH} \\ ⌊ \frac{\begin{matrix}{n}_{PUCCH}^{( 1 )} - \\ c \cdot {N}_{cs}^{( 1 )} / {Δ}_{shift}^{PUCCH}\end{matrix}}{c \cdot {N}_{sc}^{RB} / {Δ}_{shift}^{PUCCH}} ⌋ + {N}_{RB}^{( 2 )} + ⌈ \frac{{N}_{cs}^{( 1 )}}{8} ⌉ & otherwise\end{matrix} \\ c = \{ \begin{matrix}3 & normal cyclic prefix \\ 2 & extended cyclic prefix\end{matrix} \\ {n}_{PRB} = \{ \begin{matrix}⌊ \frac{m}{2} ⌋ & if ( m + {n}_{s} mod 2 ) mod 2 = 0 \\ {N}_{RB}^{UL} - 1 - ⌊ \frac{m}{2} ⌋ & if ( m + {n}_{s} mod 2 ) mod 2 = 1\end{matrix}$$

Herein, mod represents a modulo operation. N⁽¹⁾_{CS} as the number of CSs used in the PUCCH format 1/1a/1b in a resource block in which PUCCH formats 1/1a/1b and 2/2a/2b are mixed becomes the integer times of Δ^{PUCCH}_{shift} and is transferred by the higher layer signaling. N⁽²⁾_{RB}represents a bandwidth represented in terms of a resource block usable for the PUCCH format 2/2a/2b transmission in each slot.

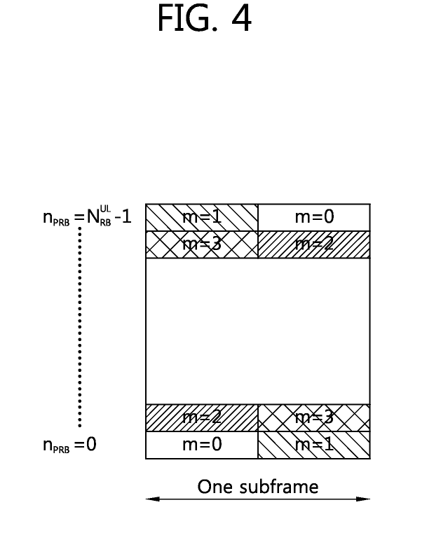

FIG. 4 illustrates an example mapping the PUCCH to physical RBs according to Equation 1. The physical RB index n⁽¹⁾_{PUCCH} is determined according to the resource index n_{PRB} and the PUCCH corresponding to each m is frequency-hopped by the unit of the slot.

In the carrier aggregation (CA) environment, the HARQ ACK/NACK signal for a plurality of downlink component carriers is transmitted through one uplink component carrier. In this case, the ACK/NACK signal of 1 bit per one codeword CW transmitted through the downlink is transmitted through the uplink.

The HARQ ACK/NACK signal for the downlink is transmitted on the PUCCH.

In order to transmit the ACK/NACK signal, the base station may implicitly allocate an ACK/NACK resource index. For the base station to implicitly allocate the ACK/NACK resource index means allocating a resource index calculated by using nCCE meaning the number of the CCE among one or more CCEs constituting the PDCCH of the component carrier as a parameter. In the specification, in terms of the user equipment, this is expressed as ‘implicit acquisition of the resource index’ to correspond to the implicit resource index allocation of the base station.

The base station may also explicitly allocate the resource index. For the base station to explicitly the resource index to the user equipment means allocating a resource index of a PUCCH dedicated to a specific user equipment to the user equipment from the base station through a separate resource allocation indicator without depending on n_{CCE.} In this case, the separate resource allocation indicator from the base station includes signaling from a higher layer or a physical layer. Further, the resource allocation indicator may be included in the PDCCH as control information or system information. In the specification, in terms of the user equipment, this is expressed as ‘explicit acquisition of the resource index’ to correspond to the explicit resource index allocation of the base station.

In this case, the base station may use a bit to be used for an indicator for transferring other control information for transferring other control information to transfer the resource allocation indicator. For example, a resource for transmitting the HARQ ACK/NACK may be allocated by using a bit allocated to an uplink transmission power control (TPC) command which is duplicatively transmitted. A message transferred onto the PDCCH includes a TPC to control uplink transmission power. In general, a DCI format that indicates a downlink grant may include a TPC field of 2 bits for power control for the PUCCH and a DCI format that indicates an uplink grant may include a TPC field of 2 bits for power control for the PUSCH. Due to a structure of PDCCH signaling, the TPC command is protected by the cyclic redundancy check (CRC). Therefore, except for a case in which the user equipment is incapable of receiving a PDCCH message itself, the received TPC command has high reliability. In association with the CA environment, the PDCCH of each component carrier may transmit the TPC command for the PUCCH of the same uplink component carrier. For example, the HARQ ACK/NACK signal for a plurality of downlink component carriers is transmitted through one uplink component carrier. In this case, the same TPC commands may be transmitted through the plurality of downlink component carriers for power control of the same uplink PUCCH.

Therefore, the base station may transmit the resource allocation indicator, for example, an ACK/NACK transmission resource indicator (referred to as ‘ARI’) by using the bit to be used for the uplink TPC command which is duplicatively transmitted. The ARI is the indicator that allocates the resource to be used when the user equipment transmits the HARQ ACK/NACK signal for the downlink.

In the CA environment, the TPC field of the PDCCH corresponding to the PDSCH on the primary component carrier may be used as the TPC command the TPC field of the PDCCH corresponding to the PDSCH on the secondary component carrier may be used as the ARI. Even in the case of the TDD using a single carrier, a TPC field transmitted onto the PDCCH of a specific downlink subframe may be used as the TPC command and the ARI may be transmitted may be transmitted onto another downlink subframe by using a bit allocated to the TPC field.

An ARI mapping table for allocating the resource to the ARI may be transmitted to the user equipment by higher layer signaling in advance. That is, a set of explicitly allocated resources and an ARI value corresponding thereto may be transferred by the higher layer signaling in advance. The ARI mapping table is constituted by a value indicated by the ARI and the correspondingly allocated ACK/NACK transmission resource.

In the CAN environment, the number of HARQ ACK/NACK transmission resources required to configure the ARI mapping table may be determined according to the number of component carriers constituted through the RRC, a transmission mode associated with how many codewords to transmit for each component carrier in the subframe, a type of a PUCCH format to transmit the HARQ ACK/NACK signal, and the like. Further, in the case of the TDD using the single carrier, the number of HARQ ACK/NACK transmission resources may be determined according to the number of downlink subframes associated with the uplink subframe, a type of the PUCCH format to transmit the HARQ ACK/NACK signal, and the like.

Table 3 shows one implementation example of the ARI mapping table used in the present invention.

TABLE 3

| ACK/NACK Resource | Mapped ACK/NACK |
|---|---|
| Indicator(ARI) | transmission resources |
| 00 | First resource set, N₁ |
| 01 | Second resource set, N₂ |
| 10 | Third resource set, N₃ |
| 11 | Fourth resource set, N₄ |

Table 3 as one example of the ARI mapping table configured for easy description and the ARI mapping table may be configured in various methods within the technical spirit of the present invention.

A resource set Nₖ (k=1, 2, 3, 4) has as components resources of the same number as the number of transmission resources to be allocated through the ARI.

For example, when one transmission resource is allocated through the ARI, each Nₖ is a resource set (for example, {n}, n represents the transmission resource) having one transmission resource which is not duplicated with each other as an element and when two transmission resources are allocated through the ARI, each Nₖ is a resource set (for example, {n1, n2}) having two transmission resources which are not duplicated with each other as a component.

Resources allocated to the user equipment become a resource set indicated by the ARI on the ARI mapping table. For example, when a value of the ARI is ‘01’, transmission resources of a resource set N₂ are allocated to the user equipment.

Meanwhile, PUCCH format 1b using channel selection in the PUCCH format to transmit the HARQ ACK/NACK signal for the downlink may transmit the ACK/NACK signal of 2 to 4 bits.

In the channel selection, the HARQ ACK/NACK signal is transmitted by using a table in which both a resource to be used for transmission and a modulation symbol of a message to be transmitted are mapped to the message to be transmitted.

A table for the channel selection may be transferred to the user equipment and the base station by the higher layer signaling.

The table for the channel selection is configured differently according to an M value (the number of HARQ response signals to be transmitted with one symbol value) and the number of resource indexes for configuring the table for the channel selection also depends on the M value. Resources constituting the table for the channel selection may all be allocated in an explicit method and all of the resources may be allocated in an implicit method, and some of the resources may be allocated in the explicit method and remaining resources may be allocated in the implicit method.

The user equipment may allocate the ACK/NACK resource mapped with the ACK/NACK signal to be transmitted on the table for the channel selection and transmit the ACK/NACK signal (the modulation symbol of the ACK/NACK signal) by using the allocated ACK/NACK resource.

Table 4 illustrates one example of the table for the channel selection in the case of M=4.

TABLE 4

| HARQ-ACK(0), HARQ-ACK(1), | | b(0), |
|---|---|---|
| HARQ-ACK(2), HARQ-ACK(3) | n⁽¹⁾_{PUCCH} | b(1) |
| ACK, ACK, ACK, ACK | n⁽¹⁾_{PUCCH, 1} | 1, 1 |
| ACK, ACK, ACK, NACK/DTX | n⁽¹⁾_{PUCCH, 1} | 1, 0 |
| NACK/DTX, NACK/DTX, NACK, DTX | n⁽¹⁾_{PUCCH, 2} | 1, 1 |
| ACK, ACK, NACK/DTX, ACK | n⁽¹⁾_{PUCCH, 1} | 1, 0 |
| NACK, DTX, DTX, DTX | n⁽¹⁾_{PUCCH, 0} | 1, 0 |
| ACK, ACK, NACK/DTX, NACK/DTX | n⁽¹⁾_{PUCCH, 1} | 1, 0 |
| ACK, NACK/DTX, ACK, ACK | n⁽¹⁾_{PUCCH, 3} | 0, 1 |
| NACK/DTX, NACK/DTX, NACK/DTX, NACK | n⁽¹⁾_{PUCCH, 3} | 1, 1 |
| ACK, NACK/DTX, ACK, NACK/DTX | n⁽¹⁾_{PUCCH, 2} | 0, 1 |
| ACK, NACK/DTX, NACK/DTX, ACK | n⁽¹⁾_{PUCCH, 0} | 0, 1 |
| ACK, NACK/DTX, NACK/DTX, NACK/DTX | n⁽¹⁾_{PUCCH, 0} | 1, 1 |
| NACK/DTX, ACK, ACK, ACK | n⁽¹⁾_{PUCCH, 3} | 0, 1 |
| NACK/DTX, NACK, DTX, DTX | n⁽¹⁾_{PUCCH, 1} | 0, 0 |
| NACK/DTX, ACK, ACK, NACK/DTX | n⁽¹⁾_{PUCCH, 2} | 1, 0 |
| NACK/DTX, ACK, NACK/DTX, ACK | n⁽¹⁾_{PUCCH, 3} | 1, 0 |
| NACK/DTX, ACK, NACK/DTX, NACK/DTX | n⁽¹⁾_{PUCCH, 1} | 0, 1 |
| NACK/DTX, NACK/DTX, ACK, ACK | n⁽¹⁾_{PUCCH, 3} | 0, 1 |
| NACK/DTX, NACK/DTX, ACK, NACK/DTX | n⁽¹⁾_{PUCCH, 2} | 0, 0 |
| NACK/DTX, NACK/DTX, NACK/DTX, ACK | n⁽¹⁾_{PUCCH, 3} | 0, 0 |
| DTX, DTX, DTX, DTX | N/A | N/A |

In Table 4, HARQ-ACK(0) to HARQ-ACK(3) are ACK/NACK types for a codeword to judge whether the signal is normally received (decoded).

n⁽¹⁾_{PUCCH} represents a HARQ ACK/NACK resource to be used for transmission by using PUCCH format 1b. In this case, respective ACK/NACK resources constituting the table for the channel selection, for example, {n⁽¹⁾_{PUCCH,0} n⁽¹⁾_{PUCCH,1} n⁽¹⁾_{PUCCH,2} n⁽¹⁾_{PUCCH,3}} shown in Table 4 are implicitly or explicitly allocated transmission resources.

b(0, and b(1) represent QPSK symbols of the ACK/NACK signal to be transmitted. Since the case of discontinuous transmission (DTX) corresponds to for example, a case in which the user equipment is incapable of receiving the PDCCH, the user equipment does not transmit the ACK/NACK signal in the subframe that transmits the HARQ ACK/NACK signal.

The user equipment transmits the corresponding symbols (b(0),b(1)) onto the PUCCH by using the ACK/NACK resource n⁽¹⁾_{PUCCH} mapped to the ACK/NACK type corresponding to decoding results of received PDSCHs. For example, when all of the types of the ACK/NACK signals to be transmitted are ACK, (1,1) which is a value of the corresponding symbol (b(0),b(1)) onto the PUCCH by using the ACK/NACK resource n⁽¹⁾_{PUCCH,1}.

In the case of PUCCH format lb using the channel selection, resources of the same number as the number of bits of the transmitted HARQ ACK/NACK signal is required and the HARQ ACK/NACK signal of up to maximum 4 bits may be transmitted.

The table for the channel selection is one example for describing the technical spirit of the present invention and the present invention is not limited thereto. It should be noted that the table for the channel selection may be configured in various schemes within the scope of the technical spirit of the present invention.

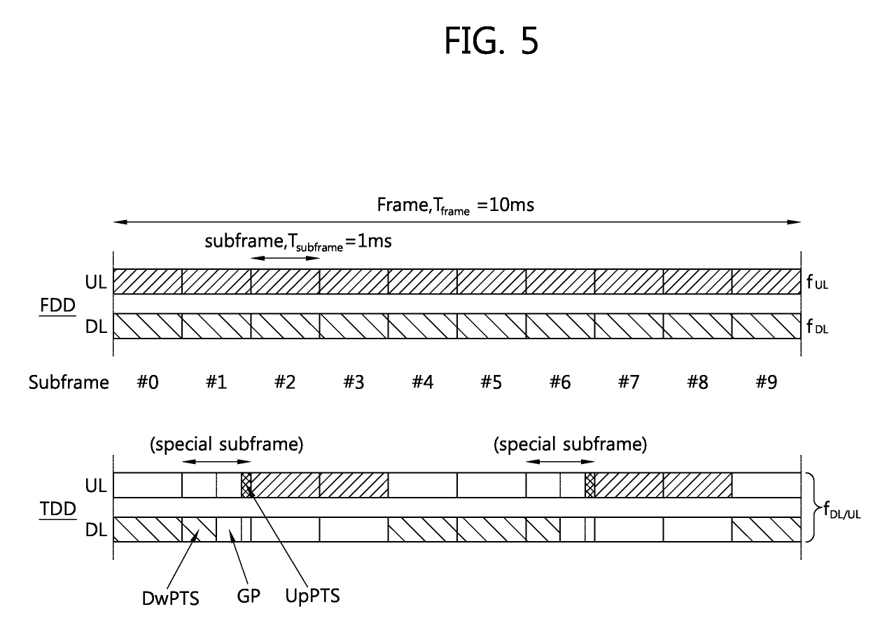

FIG. 5 schematically illustrates time and frequency structures of an uplink/downlink in FDD and TDD modes.

In the case of the FDD, a frequency of a carrier used for uplink transmission and a frequency of a carrier used for downlink transmission are respectively present, and as a result, the uplink transmission and the downlink transmission may be simultaneously performed in the cell.

In the case of the TDD, the uplink transmission and the downlink transmission are continuously temporally divided based on one cell. Since the same carrier is used for the uplink transmission and the downlink transmission, the base station and the user equipment are repeatedly switched between a transmission mode and a transmission mode. In the case of the TDD, a special subframe is provided to provide a guard time for mode switching between transmission and reception. The special subframe may be constituted by a downlink part DwPTS, a guard period GP, and an uplink part UpPTS. Neither the uplink transmission nor the downlink transmission is performed during the guard period.

Table 5 illustrates an uplink-downlink configuration in the TDD mode.

TABLE 5

| Uplink-downlink | Downlink-to-Uplink | Subframe number | | | | | | | | | |
|---|---|---|---|---|---|---|---|---|---|---|---|
| configuration | Switch-point periodicity | 0 | 1 | 2 | 3 | 4 | 5 | 6 | 7 | 8 | 9 |
| 0 | 5 ms | D | S | U | U | U | D | S | U | U | U |
| 1 | 5 ms | D | S | U | U | D | D | S | U | U | D |
| 2 | 5 ms | D | S | U | D | D | D | S | U | D | D |
| 3 | 10 ms | D | S | U | U | U | D | D | D | D | D |
| 4 | 10 ms | D | S | U | U | D | D | D | D | D | D |
| 5 | 10 ms | D | S | U | D | D | D | D | D | D | D |
| 6 | 5 ms | D | S | U | U | U | D | S | U | U | D |

In Table 5, an uplink-to-downlink switch-point periodicity according to the uplink-downlink configuration is expressed and further, according to the uplink-downlink configuration, it is expressed whether the corresponding subframe is an uplink subframe, a downlink subframe, or the special subframe for each subframe number.

Referring to Table 5, the base station and the user equipment performs the uplink and downlink transmission through seven available downlink/uplink frame configurations. In a frame structure constituted by 10 subframes, ‘D’ represents the downlink subframe and ‘U’ represents the uplink subframe. ‘S’ represents the aforementioned special subframe.

Through the downlink/uplink configuration, the transmission resource may be allocated asymmetric to the uplink transmission and the downlink transmission. Further, the downlink/uplink frame configuration used between the base station and the user equipment is not dynamically changed. For example, the base station and the user equipment that perform the downlink and uplink transmission by configuration 3 do not perform the downlink and uplink transmission by using configuration 4 by the unit of the frame. However, the configuration may be changed through RRC signaling, and the like depending on a change of a network environment or a system.

Meanwhile, in the case of the FDD, the user equipment transmits the HARQ ACK/NACK for the PDSCH received in subframe n-4, in subframe n.

In the case of the TDD, the user equipment transmits the HARQ ACK/NACK for the PDSCH received in subframe(s) n-k, in uplink subframe n. In this case, k represents a component of K and K may be defined by Table 6. K is determined by the uplink-downlink (UL-DL) configuration and subframe n, and may be constituted by M components of {k₀,k₁, . . . , k_{M-1}}.

TABLE 6

| UL-DL | Subframe n | | | | | | | | | |
|---|---|---|---|---|---|---|---|---|---|---|
| Configuration | 0 | 1 | 2 | 3 | 4 | 5 | 6 | 7 | 8 | 9 |
| 0 | — | — | 6 | — | 4 | — | — | 6 | — | 4 |
| 1 | — | — | 7, 6 | 4 | — | — | — | 7, 6 | 4 | — |
| 2 | — | — | 8, 7, 4, 6 | — | — | — | — | 8, 7, 4, 6 | — | — |
| 3 | — | — | 7, 6, 11 | 6, 5 | 5, 4 | — | — | — | — | — |
| 4 | — | — | 12, 8, 7, 11 | 6, 5, 4, 7 | — | — | — | — | — | — |
| 5 | — | — | 13, 12, 9, 8, | — | — | — | — | — | — | — |
| | | | 7, 5, 4, 11, 6 | | | | | | | |
| 6 | — | — | 7 | 7 | 5 | — | — | 7 | 7 | — |

Referring to Table 5, subframes written with numerical numbers in Table 6 are subframes that perform the uplink transmission.

The HARQ ACK/NACK signal for the downlink subframe may be transmitted through the uplink subframe associated with the downlink subframe. For example, referring to Table 6, when the uplink-downlink configuration is 0 and n is 2, k is 6. Therefore, subframe 2 which is a current subframe is an uplink subframe that transmits the HARQ ACK/NACK for the PDSCH received in a sixth subframe before.

Similarly, when the uplink-downlink configuration is 4 and n is 3, K={6, 5, 4, 7}. Therefore, A/N information for the PDSCH received in 6, 5, 4, and 7-th subframes before is transmitted through the uplink in subframe 3 which is a current subframe.

Likewise, in the case of a TDD system, referring to Table 6, two or more downlink subframes may be associated with one uplink subframe. Even in the CA environment, the HARQ ACK/NACK signal for the plurality of downlink component carriers is transmitted through one uplink component carrier. In this case, the TPCs are transmitted onto the PDCCH for power control for the PUCCH of the same uplink subframe in the downlink subframes associated with the same uplink subframe, which may consequently serve as overhead of the downlink control information.

Therefore, the ARI is transmitted by using the bit to be allocated to the TPC field which is duplicated and the HARQ ACK/NACK signal may be transmitted by using the same, as described above.

Meanwhile, referring to Table 6, when the HARQ ACK/NACK signal for the plurality of downlink subframes should be transmitted to one uplink subframe as described in uplink-downlink configuration 5, a lot of transmission bits are required in order to transmit the HARQ ACK/NACK symbol for each of the respective downlink subframes. In this case, a method of transmitting the ACK/NACK signal for each downlink subframe through time domain bundling may be considered.

A plurality of HARQ ACK/NACK signals may be bundled in various methods. For example, the downlink component carriers to be bundled or the ACK/NACK signal for the downlink subframe may be bundled by a logical product operation. That is, when the downlink component carrier or the HARQ ACK/NACK information to be bundled is all ACK, the ACK signal may be transmitted as the HARQ ACK/NACK signal that represents the ACK/NACK signals to be bundled. When the HARQ ACK/NACK information for at least one component carrier or subframe is NACK, the NACK signal may be transmitted as the HARQ ACK/NACK signal that represents the ACK/NACK signals to be bundled. When the HARQ ACK/NACK information for at least one component carrier or subframe is DTX, a DTX signal may be transmitted as the HARQ ACK/NACK signal that represents the ACK/NACK signals to be bundled. When HARQ ACK/NACK information for all component carriers or subframes is DTX, the HARQ ACK/NACK signal may not be sent.

Meanwhile, as both the SR and the PUCCH for the HARQ ACK/NACK have been described above, a structure of SR PUCCH format 1 is the same as that of ACK/NACK PUCCH format 1a/1b. Herein, a cyclic time shift of a base RS sequence is modulated into time domain orthogonal block spreading.

Simple on-off keying is used as the SR. When the user equipment transmits the SR with the modulation symbol d(0)=1 to request a UL grant (positive SR transmission), and does not make the SR, the user equipment does not transmit the SR (negative SR transmission).

Since the HARQ ACK/NACK structure is reused for the SR, PUCCH resource indexes (that is, different cyclic time shifts/orthogonal code combinations) which are different in the same PUCCH region may be allocated to the SR (format 1) or the HARQ ACK/NACK (format 1b/1a) from different user equipments. This causes orthogonal multiplexing of the SR and the HARQ ACK/NACK signal in the same PUCCH region. The PUCCH resource index used by the user equipment in order to transmit the SR may be configured by UE-specific higher layer signaling.

When the user equipment should transmit the SR in the same subframe as the subframe in which the user equipment transmits the CQI, the user equipment drops the CQI and transmits only the SR to maintain a low cubic metric (CM) of a transmission signal. Similarly thereto, even when the user equipment should transmit both the SR and the sounding reference signal (SRS), the user equipment may transmit only the SR without transmitting the SRS.

Meanwhile, the user equipment transmits the ACK/NACK signal to an allocated SR PUCCH resource (hereinafter, referred to as ‘SR resource’) in a positive SR situation and transmits the ACK/NACK signal to an allocated ACK/NACK PUCCH resource (hereinafter, referred to as ‘ACK/NACK resource’) in a negative SR situation to transmit both the HARQ ACK.NACK signal and the SR. Therefore, there may be a case in which both the SR and the HARQ ACK/NACK signal should be transmitted in the same subframe (hereinafter, referred to as ‘positive SR situation’), in regard to a positive SR.

For example, in a TDD environment using the channel selection, when both the HARQ ACK/NACK signal and the SR are transmitted in the same subframe, the user equipment may transmit the bundled ACK/NACK signal or the multiplexed ACK/NACK signal onto the ACK/NACK which is allocated with respect to the positive SR. Further, the user equipment may transmit the signal to an SR resource allocated with a modulation symbol to be transmitted, for example, a QPSK symbol of 2 bits by using PUCCH format 1b.

Table 7 shows one example of a table in which multiple ACK/NACK responses and QPSK symbols b(0) and b(1), in the positive SR situation.

TABLE 7

| Number of ACK among multiple | |
|---|---|
| (U_{DAI} + N_{SPS}) ACK/NACK responses | b(0), b(1) |
| 0 or None (UE detect at least | 0, 0 |
| one DL assignment is missed) | |
| 1 | 1, 1 |
| 2 | 1, 0 |
| 3 | 0, 1 |
| 4 | 1, 1 |
| 5 | 1, 0 |
| 6 | 0, 1 |
| 7 | 1, 1 |
| 8 | 1, 0 |
| 9 | 0, 1 |

Herein, a downlink assignment indicator (DAI) is a message of 2 bits transmitted onto the PDCCH and a value of the DAI within a DL DCI format (e.g., DL DCI format 1A/1B/1D/1/2/2A/2B/2C) in the case of the TDD indicates the allocation (assignment, PDSCH scheduling by PDCCH or SPS release indicating by PDCCH) order of the corresponding subframe among downlink subframes scheduled in association with one uplink subframe. Therefore, U_{DAI} may be a total number acquired by summing up PDCCHs in which the base station instructs the corresponding UE to transmit the PDCCH for PDSCH transmission and release the DL SPS (of course, is a value corresponding to a DL subframe associated with one UL subframe).

Further, N_{SPS} has a value of 1 (the number of PDSCHs) when the SPS is transmitted within the corresponding downlink subframe. While the SPS is activated, since one PDSCH is sensed or no PDSCH is sensed in the downlink subframes associated with one uplink subframe, the value of N_{SPS} may be 1 or 0.

Therefore, U_{DAI}+N_{SPS} is a sum of the number of PDCCHs and the number of SPS PDSCHs sensed by the user equipment in association with one uplink subframe and in Table 7, the number of PDSCHs as a target of the ACK signal among all of the PDSCHs sensed by the user equipment in association with one uplink subframe with a predetermined QPSK symbol. The mapped QPSK symbol may be transmitted onto a previously allocated SR resource by using PUCCH format 1b.

Meanwhile, when Table 7 is used in the positive SR situation, it is difficult to check which PDSCH is not transmitted in the base station. That is, when the number of PDSCH scheduled by the base station and the number of PDSCH which the user equipment succeeds in receiving do not coincide with each other, the base station should transmit all PDSCHs which the base station transmitted.

Therefore, a method in which the base station may check which PDSCH is not transmitted while transmitting the HARQ ACK/NACK signal and the SR in one subframe may be considered, in addition to the method using Table 7 in the positive SR situation.

Hereinafter, the method in which the base station may check which PDSCH is not transmitted while transmitting the HARQ ACK/NACK signal and the SR in one subframe will be described.

<Method of Additionally Allocating SR Resource>

A method of allocating an additional SR resource may be considered so as for the base station to check which PDSCH is not transmitted while transmitting the HARQ ACK/NACK signal and the SR ion one subframe.

The PUCCH resource index used by the user equipment in order to transmit the SR may be configured by UE-specific higher layer signaling. Therefore, the SR resource may be additionally allocated through the higher layer signaling. Further, the SR resource may be allocated by using the ARI.

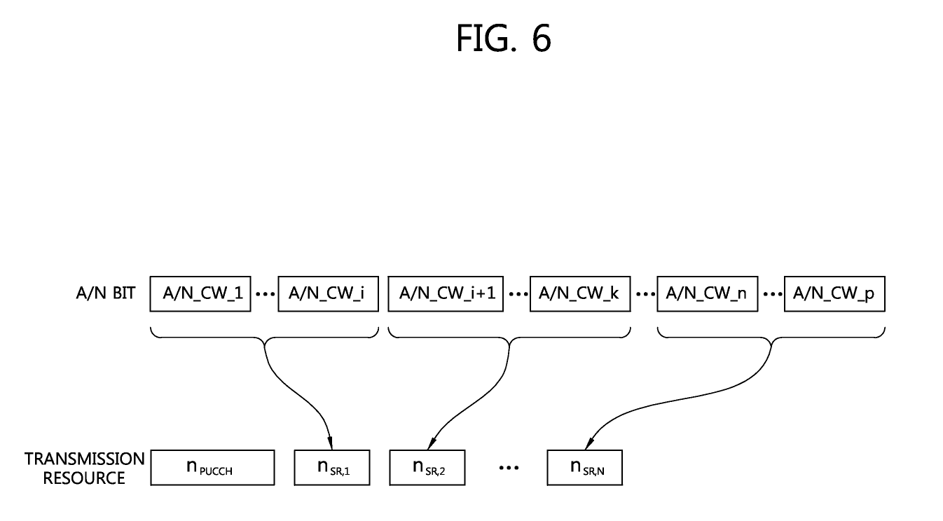

The UE may transmit the HARQ ACK/NACK signal onto a plurality of PUCCHs by using the additionally allocated SR resource. FIG. 6 is a diagram schematically describing a positive SR situation in which a HARQ ACK/NACK signal is transmitted by using additionally allocated SR resources in a TDD system according to the present invention.

As illustrated in the figure, ACK/NACK bits may be transmitted by using not the ACK/NACK resource but the SR resource, in the positive SR. In this case, the ACK/NACK signal transmitted by using the SR resource may be transmitted in PUCCH format 1a or 1b.

Referring to FIG. 6, SR resources (n_{SR,2} to n_{SR,N}) may be additionally allocated through the higher layer signaling, in order to transmit the HARQ ACK/NACK bit.

Among the HARQ ACK/NACK bits, A/N_CW_{—}1 to A/N_CW_i are transmitted by using the SR resource n_{SR,1} and A/N_CW_i+1 to A/N_CW_k are transmitted by using the SR resource n_{SR,2.} Similarly, A/N_CW_n to A/N_CW_p are transmitted by using the SR resource n_{SR,N} to transmit all ACK/NACK bits to be transmitted by using the SR resources.

Therefore, the HARQ ACK/NACK bits may be distributed and transmitted onto a plurality of PUCCHs using a plurality of SR resources. That is, A/N_CW_{—}1 to A/N_CW_i are transmitted onto the PUCCH using the SR resource n_{SR,1} and A/N_CW_i+1 to A/N_CW_k are transmitted onto the PUCCH using the SR resource n_{SR,2}. In the same method, A/N_CW_n to A/N_CW_p may be transmitted onto the PUCCH using the SR resource n_{SR,N}. In an example of FIG. 6, A/N_CW_i represents the ACK/NACK bit (ACK/NACK signal) for an i-th codeword transmitted to the PDSCH. Further, n_{SR,N} represents an N-th SR resource among all allocated SR resources.

The ACK/NACK signals to be transmitted may be the ACK/NACK signals for the PDSCHs transmitted by the plurality of component carriers in the CA environment. Further, the ACK/NACK signals may be the ACK/NACK signals for the PDSCHs transmitted by the single carrier. In this case, one codeword or two codewords may be transmitted onto the PDSCH of each (component) carrier.

The ACK/NACK signals for the codewords transmitted onto the PDSCH in the same downlink subframe may be transmitted by using the same SR resource. In the example of FIG. 6, assumed that the ACK/NACK signals of A/N_CW_{—}1 to A/N_CW_i, the ACK/NACK signals of A/N_CW_i+1 to A/N_CW_k, . . . , the ACK/NACK signals of A/N_CW_n to A/N_CW_p are the ACK/NACK signals for the codewords transmitted in the same downlink subframe, A/N_CW_{—}1 to A/N_CW_i, A/N_CW_i+1 to A/N_CW_k, . . . , A/N_CW_n to A/N_CW_p may be transmitted by using different SR resources n_{SR,1} to n_{SR,N,} respectively. Therefore, the HARQ ACK/NACK bits may be distributed and transmitted onto the plurality of PUCCHs using the plurality of SR resources. That is, if A/N_CW_{—}1 to A/N_CW_i are the ACK/NACK signals for a codeword transmitted to a first subframe, A/N_CW_{—}1 to A/N_CW_i are transmitted onto the PUCCH using the first SR resource n_{SR},ᵢ, if A/N_CW_i+1 to A/N_CW_k are the ACK/NACK signals for a codeword transmitted to a second subframe, A/N_CW_i+1 to A/N_CW_k are transmitted onto the PUCCH using the second SR resource n_{SR,2}. In the same method, if A/N_CW_n to A/N_CW_p are the ACK/NACK signals for a codeword transmitted to a last subframe, A/N_CW_n to A/N_CW_p are transmitted onto the PUCCH using the SR resource n_{SR}, which is allocated last.

Further, all of the ACK/NACK signals to be transmitted are divided for each bit to be sequentially transmitted by using the allocated SR resources. In FIG. 6, assumed that A/N_CW_{—}1 to A/N_CW_i, A/N_CW_i+1 to A/N_CW_k, . . . , A/N_CW_n to A/N_CW_p are the ACK/NACK signals divided for each predetermined bit, A/N_CW_{—}1 to A/N_CW_i, A/N_CW_i+1 to A/N_CW_k, . . . , A/N_CW_n to A/N_CW_p may be sequentially transmitted by using the SR resources n_{SR,1} to n_{SR,N}. Therefore, the HARQ ACK/NACK bits may be distributed and transmitted onto the plurality of PUCCHs using the plurality of SR resources. That is, a first bit group, A/N_CW_{—}1 to A/N_CW_i are transmitted onto the PUCCH using the SR resource n_{SR,1} and a second bit group, A/N_CW_i+1 to A/N_CW_k are transmitted onto the PUCCH using the SR resource n_{SR,2}. In the same method, a last bit group, A/N_CW_n to A/N_CW_p may be transmitted onto the PUCCH using the SR resource n_{SR,N}.

In the positive SR situation, the unit of the ACK/NACK signal to be transmitted for each SR resource, for example, whether to transmit the ACK/NACK signals for the codeword transmitted in one downlink subframe by using the same SR resource or whether to transmit all of the ACK/NACK signals for each predetermined bit may be determined in advance between the user equipment and the base station or transferred to the user equipment through the higher layer signaling.

In this case, as described above, since the HARQ ACK/NACK signal is transmitted by using different SR resources, multiple PUCCH transmission is achieved in one uplink subframe. The multiple PUCCH transmission may be achieved by performing PUCCH transmission for each channel by using a plurality of channels (a plurality of resources) on the primary component carrier when the uplink transmission is performed by only one component carrier, that is, the primary component carrier. Further, the multiple PUCCH transmission may be achieved by performing at least one PUCCH transmission by using at least one channel (resource) on each component carrier when the uplink transmission is performed by the plurality of component carriers, that is, the primary component carrier and at least one secondary component carrier. Since the multiple PUCCH transmission is achieved through the plurality of channels (the plurality of resources), a diversity gain may be obtained.

Further, the ACK/NACK transmission using the SR resource may be performed in PUCCH format 1a or PUCCH format 1b. In this case, the ACK/NACK signals to be transmitted may be transmitted through multiplexing or bundling depending on the PUCCH transmission format. The PUCCH format to be used for transmission may be changed according to the aforementioned predetermined unit of the transmission ACK/NACK signal for each SR resource. Further, the PUCCH format to be used for transmission may be determined in advance between the user equipment and the base station by using the unit of the transmission ACK/NACK signal for each resource or transferred to the user equipment through the higher layer signaling.

For example, if a transmission format of n_{SR,1} is PUCCH format 1b, A/N_CW_1 and A/N_CW_{—}2 may be transmitted through multiplexing in i=2, but A/N_CW_1 to A/N_CW_i may be transmitted through bundling in i>2.

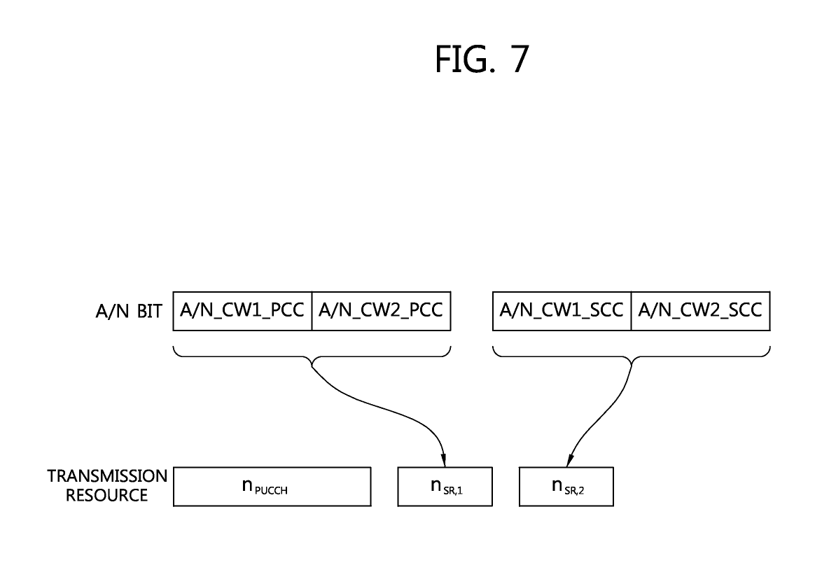

FIG. 7 is a diagram describing one example in which when 2 element carriers transmitted to the downlink transmit 2 codewords, respectively in a TDD CA environment under the positive SR situation, the HARQ ACK/NACK is transmitted by additionally allocating the SR resource.

In an example of FIG. 7, HARQ ACK/NACK transmission using two SR resources n_{SR,1} and n_{SR,2} is achieved by additionally allocating one SR resource.

When the transmission using the SR resource is achieved in PUCCH format 1a, 1 bit-transmission may be achieved in PUCCH format 1a as shown in Table 1, an das a result, the ACK/NACK signals for 2 codewords transmitted by the primary component carrier may be transmitted to the PUCCH using n_{SR,1} through bundling and the ACK/NACK signals for two codewords transmitted by the secondary component carrier may be transmitted onto the PUCCH using n_{SR,2} through bundling. In this case, the base station may judge whether the user equipment successfully receives information transmitted onto the PDSCH for each of the primary component carrier and the secondary component carrier, and as a result, the base station may retransmit only information which is not successfully transmitted again without transmitting all information again.

When the transmission using the SR resource is achieved in PUCCH format 1b, 2 bit-transmission may be achieved in PUCCH format 1b as shown in Table 1, an das a result, the ACK/NACK signals for 2 codewords transmitted by the primary component carrier may be transmitted to the PUCCH using n_{SR,1} through not bundling but multiplexing and the ACK/NACK signals for two codewords transmitted by the secondary component carrier may be transmitted onto the PUCCH using n_{SR,2} through not bundling but multiplexing. In this case, the base station determines whether the downlink transmission is successfully achieved for each codeword to selectively retransmit only a codeword which is not successfully transmitted.

4-bit ACK/NACK is transmitted in the positive SR situation in FIG. 7, but the present invention is not limited thereto. Further, the ACK/NACK signal is transmitted onto two PUCCHs by using two SR resources in FIG. 7, even with respect to the number of SR resource and the number of PUCCHs which may be used to transmit the HARQ ACK/NACK signal.

For example, when the HARQ ACK/NACK signal is 2 bits, the ACK/NACK signal may be multiply transmitted on two PUCCHs by using two PUCCH format 1a SR resources or the ACK/NACK signal may be transmitted on one PUCCH by using one PUCCH format 1b SR resource.

When the HARQ ACK/NACK signal is 3 bits, the ACK/NACK signal may be transmitted onto two PUCCHs by using one PUCCH format 1a SR resource and one PUCCH format 1b SR resource. Further, the ACK/NACK signal may be transmitted onto three PUCCHs by using three PUCCH format 1a SR resources.

Similarly, when the HARQ ACK/NACK signal to be transmitted is 4 bits, the ACK/NACK signal may be transmitted onto two PUCCHs by using two PUCCH format 1b SR resources or on four PUCCHs by using four PUCCH format 1a SR resources or the HARQ ACK/NACK signal may be transmitted onto a plurality of PUCCHs by using a combination of the PUCCH format 1b SR resource and the PUCCH format 1a SR resource.

Meanwhile, when an ACK/NACK having the number of bits larger than the number of bits which are transmittable in the corresponding PUCCH format should be transmitted by the SR resource, the ACK/NACK signals to be transmitted may be transmitted through bundling. For example, in the case of TDD configuration 5 of Table 6, when two component carriers are transmitted to each downlink subframe, 18 PDSCH transmissions may be achieved. When time domain bundling is performed for each codeword with respect to 9 downlink subframes, a 2-bit bundled ACK/NACK signal is created for each component carrier. Therefore, in TDD configuration 5 in which the downlink transmission is achieved by two component carriers, a 4-bit bundled ACK/NACK signal may be transmitted through bundling. That is, the ACK/NACK signal may be transmitted onto two PUCCHs by allocating two PUCCH format lb SR resources in the positive SR situation.

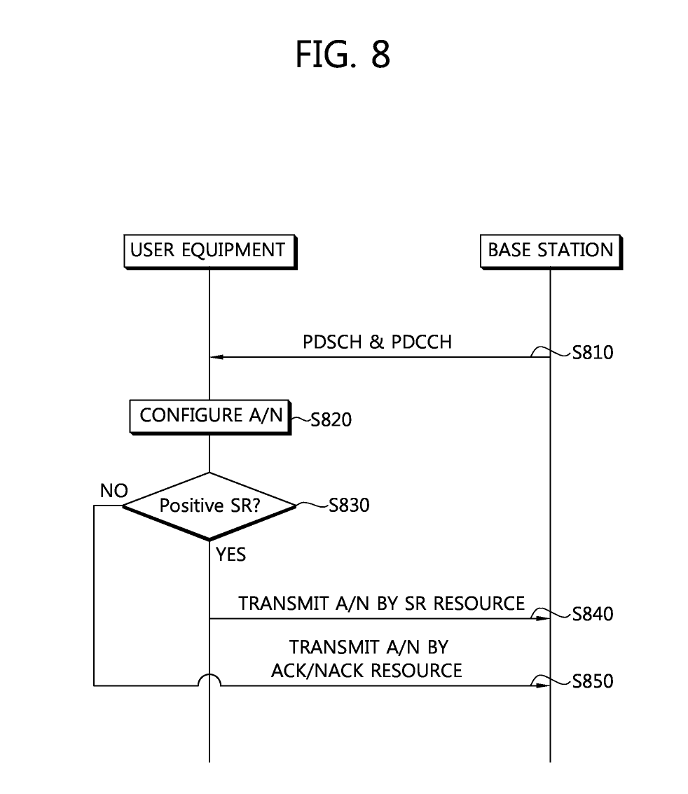

FIG. 8 is a flowchart schematically describing a method for transmitting an ACK/NACK signal by additionally allocating an SR resource in the case of a positive SR in a system according to the present invention.

Referring to FIG. 8, the downlink transmission is achieved from the base station to the user equipment (S810). Data required for the user equipment is transmitted onto the PDCCH and the PDSCH through the downlink transmission.

The user equipment configures the HARQ ACK/NACK signal to be transmitted to the base station with respect to the codeword received on the PDSCH (S820). The HARQ ACK/NACK signal is configured for each received codeword.

The user equipment judges the positive SR situation or not (S830). As described above, when the HARQ ACK/NACK signal and the SR should be transmitted in the same subframe, the ACK/NACK signal is transmitted by using the SR resource to allow the base station to recognize the positive SR situation.

When the positive SR situation is judged, the user equipment may transmit the HARQ ACK/NACK signal by using the SR resource (S840). The SR PUCCH resource may be allocated through user equipment-specific higher layer signaling. In this case, the HARQ ACK/NACK signals are divided and transmitted through a plurality of PUCCHs by allocating a plurality of SR resources, that is, additionally allocating at least one SR resource to allow the base station to judge whether the downlink transmission is successfully achieved for each downlink transmission unit, for example, codeword, component carrier, a codeword set having a predetermined number of bits, and the like. Therefore, the base station may perform retransmission for each unit of downlink transmission which is not successfully performed.

When the positive SR situation is not judged, the negative SR situation is judged, and as a result, the user equipment may transmit the HARQ ACK/NACK signal by using the ACK/NACK resource (S850).

In FIG. 8, the HARQ ACK/NACK signal is configured (S820) and the positive SR or not is judged (S830) to transmit the ACK/NACK signal by using the SR resource when the positive SR situation is judged, but the present invention is not limited thereto, and the positive SR or not may be judged and thereafter, the HARQ ACK/NACK signal may be configured or the judgment of the positive SR or not and the configuration of the HARQ ACK/NACK signal may be performed simultaneously.

<Method Using Channel Selection>

A method using the channel selection may be considered, so as for the base station to check which PDSCH is not transmitted while transmitting the HARQ ACK/NACK signal and the SR in one subframe.

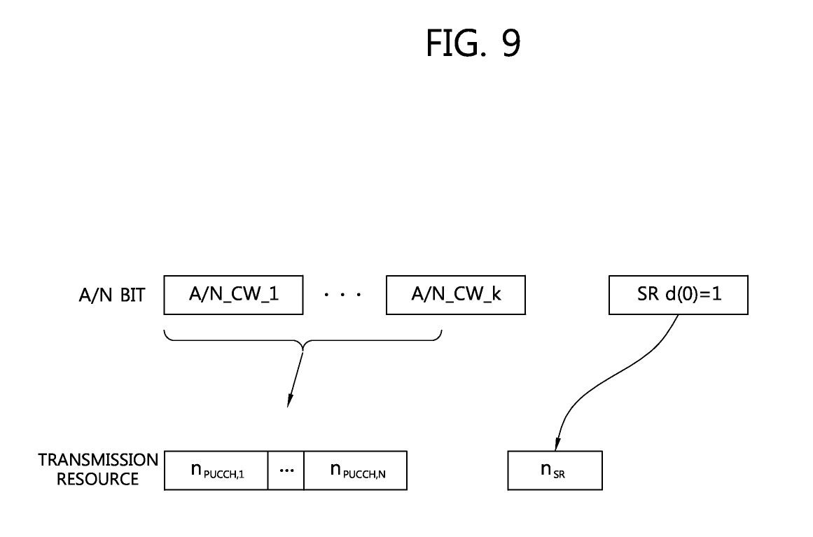

FIG. 9 is a diagram schematically describing transmission of a HARQ ACK/NACK signal and a positive SR, when a channel selection is configured in a TDD system according to the present invention.

As illustrated in FIG. 9, in the positive SR, ACK/NACK bits are transmitted as an ACK/NACK resource by using the channel selection, and a symbol d(0)=1 of the positive SR may be transmitted by using the SR resource. In this case, the HARQ ACK/NACK signal may be transmitted as a PUCCH format lb by using the channel selection, and the SR may be transmitted as a PUCCH format 1.

Among the ACK/NACK bits, A/N_CW_1 to A/N_CW_k may be transmitted through the channel selection using ACK/NACK resource (index) n_{PUCCH,1} to n_{PUCCH,N}. That is, as described above, a channel selection table is configured by using the n_{PUCCH,1} to n_{PUCCH,N}, and the ACK/NACK resource corresponding to the HARQ ACK/NACK signal to be transmitted and a symbol to be transmitted may be allocated. In this case, the n_{PUCCH,1} to n_{PUCCH,N} may be implicitly allocated, and be explicitly allocated through an upper layer signaling or an ARI. Further, some of the n_{PUCCH,1} to n_{PUCCH,N} may be implicitly allocated, and some may be explicitly allocated.

Here, an A/N_CW_i means an ACK/NACK bit (ACK/NACK signal) for an i-th codeword transmitted to a PDSCH. Further, n_{PUCCH,N} means an N-th ACK/NACK resource.

In this case, the SR symbol d(0)=1 for the positive SR may be transmitted by using the SR resource. The SR resource may be allocated through a user equipment-specific upper layer signaling or an ARI.

The ACK/NACK signals to be transmitted may be ACK/NACK signals for PDSCHs transmitted by a plurality of element carriers in a CA environment. Further, the ACK/NACK signals to be transmitted may be ACK/NACK signals for PDSCHs transmitted by single carriers. In this case, 1 codeword may be transmitted on the PDSCH of each (element) carrier, and 2 codeword may be transmitted.

Meanwhile, in the TDD environment, an ACK/NCAK signal of 4 bits may be transmitted as the PUCCH format lb using the channel selection. In this case, when the number of bits of the ACK/NCAK signal to be transmitted exceeds 4 bits, bundling is performed, and the bundled ACK/NACK bits may be transmitted by using the channel selection.

In the TDD environment, in the case where one or more downlink subframes are associated with one uplink subframe, when the number of HARQ ACK/NACK bits to be transmitted is 1 to 4 bits, the HARQ ACK/NACK signals are multiplexed to be transmitted as the PUCCH format lb using the channel selection.

In the TDD environment, when the number of HARQ ACK/NACK bits to be transmitted exceeds 4 bits, as described above, bundling is performed, and the bundled HARQ ACK/NACK signals may be transmitted as the PUCCH format lb using the channel selection. In the case where the bundling is performed, spatial bundling may be first performed for each subframe. Even after the spatial bundling is performed, when the ACK/NACK signal to be transmitted exceeds 4bits, time zone bundling may be performed. For the time zone bundling, a special bundling mapping table may also be used.

For example, in the case of TDD set 5 of Table 6, when two element carriers are transmitted to each downlink subframe, 18 PDSCHs are transmitted. When time zone bundling is performed for each codeword with respect to 9 downlink subframes, a 2-bit bundled ACK/NACK signal is made for each element barrier. Accordingly, in the case of the TDD set 5 in which downlink transmission is performed as two element carriers, a 4-bit bundled ACK/NACK signal may be obtained. Accordingly, the ACK/NACK signal bundled as the PUCCH format 1b using the channel selection may be transmitted.

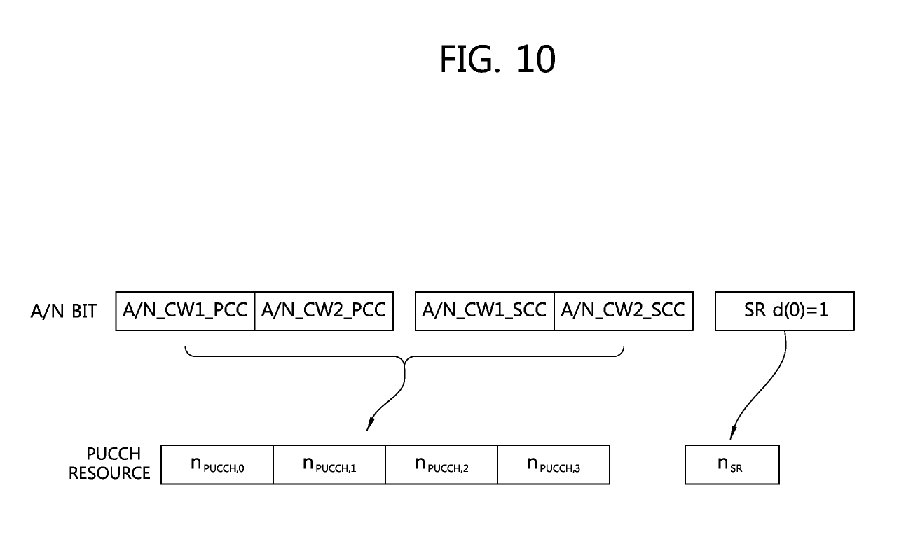

FIG. 10 is a diagram describing an example in which the HARQ ACK/NACK signal is transmitted in the PUCCH format 1b using channel selection with an ACK/NACK resource and a positive SR is transmitted with an SR resource, in the case where 2 element carriers transmitted by a downlink transmit 2 codewords, respectively in a TDD CA environment.

In the example of FIG. 10, two element carriers are transmitted to two downlink subframes associated with one uplink subframe by 2 codeword, respectively.

Referring to FIG. 10, A/N_CW1-PCC, A/N_CW2-PCC, A/N_CW1-SCC, and A/N_CW2-SCC as the ACK/NACK signals are transmitted through channel selection using allocated ACK/NACK resources (indexes) n_{PUCCH,0}, n_{PUCCH,1}, n_{PUCCH,2}, and n_{PUCCH,3}. In this case, the PUCCH format 1b is used as a PUCCH format transmitting the ACK/NACK signals.

The ACK/NACK resources n_{PUCCH,0}, n_{PUCCH,1}, n_{PUCCH,2}, and n_{PUCCH,3} may be implicitly allocated, and may also be implicitly allocated by using upper layer signaling or ARI.

A HARQ ACK/NACK signal to be transmitted has resources n⁽¹⁾_{PUCCH,0}, n⁽¹⁾_{PUCCH,1}n⁽¹⁾_{PUCCH,2}n⁽¹⁾_{PUCCH,3}of the PUCCH format lb to be transmitted by using the channel selection, as illustrated in Table 4. For example, when a user equipment successfully receives all the transmitted codewords and decodes the received codewords, a transmission symbol (1,1) is transmitted by using the n⁽¹⁾_{PUCCH,1}.

Due to the positive SR situation, the SR symbol d(0)=1 is transmitted by using an SR resource n_{SR}.

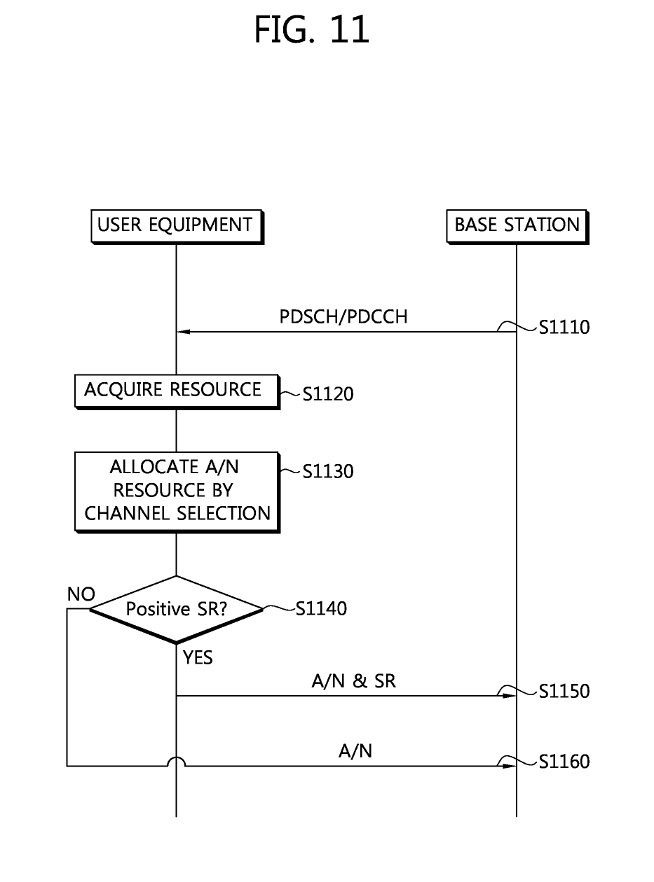

FIG. 11 is a flowchart schematically describing a method for transmitting an ACK/NACK signal by using channel selection in the case of a positive SR in the system according to the present invention.

Referring to FIG. 11, downlink transmission from a base station to a user equipment is performed (S1110). Data required for the user equipment is transmitted onto the PDCCH and the PDSCH through the downlink transmission.

The user equipment acquires a resource required for using the channel selection (S1120). The resource for using the channel selection may be implicitly allocated, and may be explicitly allocated through the upper layer signaling or the ARI.

The user equipment allocates a transmission symbol and a transmission resource corresponding to the ACK/NACK signal to be transmitted by using the channel selection (S1130). The user equipment may allocate the transmission symbol and the transmission resource through a channel selection table according to the number of bits M of the ACK/NACK signal to be transmitted, that is, the number of codewords transmitted by downlink. When the number of bits of the ACK/NACK signal to be transmitted exceeds 4 bits, the bundling is performed, and the channel selection may be applied to 2 to 4bits of the bundled ACK/NACK signal.

The user equipment determines the positive SR situation (S1140).

When the positive SR situation is determined, the user equipment transmits the HARQ ACK/NACK signal by using the ACK/NACK resource and transmits the SR symbol d(0)=1 by using the SR resource (S1150).

In this regard, the base station receives the HARQ ACK/NACK signal transmitted through the channel selection. In the channel selection, since the HARQ ACK/NACK signal to be transmitted in a range of the number of transmitted bits is multiplexed and transmitted, the base station may verify which cordword that is not successfully decoded by the user equipment is. Accordingly, the base station may re-transmit only the data in which successful transmission is not performed.

Here, the user equipment determines the positive SR situation after allocating the symbol and the resource to be transmitted for the HARQ ACK/NACK signal by using the channel selection, but it is not limited thereto, and the user equipment may first determine the positive SR situation or not. Further, since the ACK/NACK signal is transmitted by applying the channel selection using the ACK/NACK resource and the SR symbol is transmitted by using the SR resource, a procedure (channel selection) for the transmission of the HARQ ACK/NACK signal and the positive SR are determined, and the procedure for the SR transmitting the SR symbol may be performed.

In this case, the SR symbol used for the transmission may be allocated through the user equipment-specific upper layer signaling or the ARI.

When it is determined that the positive SR situation is not, since the SR is a negative SR situation, the user equipment transmits only the HARQ ACK/NACK signal to the base station (S1160).

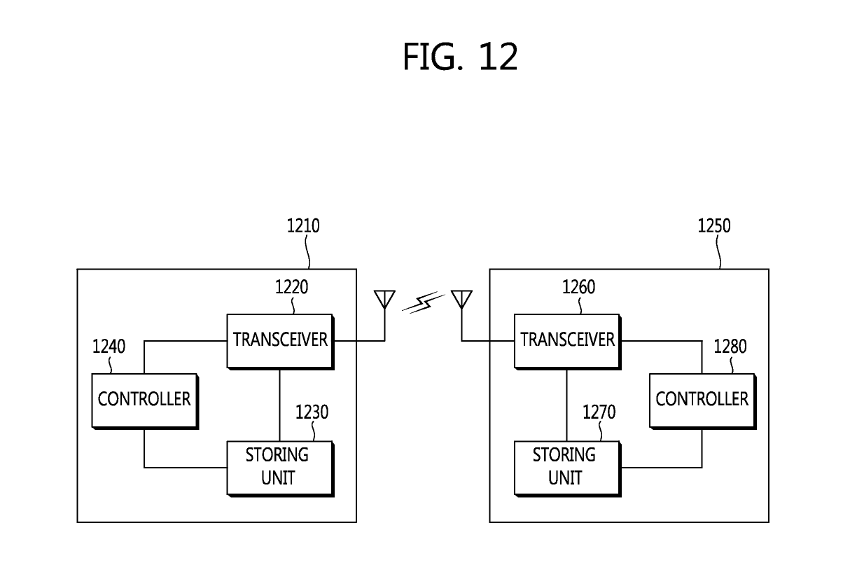

FIG. 12 is a block diagram schematically describing configurations of a user equipment and a base station in the system according to the present invention.

Referring to FIG. 12, a user equipment 1210 includes a transceiver 1220, a storing unit 1230, and a controller 1240.

The user equipment 1210 transceives necessary data through the transceiver 1220. The storing unit 1230 may store resource allocation information received through the upper layer signaling, the ARI, or the like, a channel selection table, and the like.

The controller 1240 is connected to the transceiver 1220 and the storing unit 1230 to control the transceiver 1220 and the storing unit 1230.

The controller 1240 may determine the SR positive situation or not. In the SR positive situation, the controller 1240 may transmit the HARQ ACK/NACK signal by using an additionally allocated SR resource. Further, in the SR positive situation, the controller 1240 does not additionally receive the SR resource, transmits the HARQ ACK/NACK signal through the channel selection by using the ACK/NACK resource, and may transmit the symbol for the positive SR by using the SR resource.

A base station 1250 includes a transceiver 1260, a storing unit 1270, and a controller 1280. The base station 1250 transceives necessary data through the transceiver 1260.

The storing unit 1270 may store information on the allocating resource, table information for applying the channel selection, and the like.

The controller 1280 is connected to the transceiver 1260 and the storing unit 1270 to control the transceiver 1260 and the storing unit 1270.

The controller 1280 may allocate a PUCCH transmission resource, for example, an ACK/NACK resource and/or an SR resource. The controller 1280 may implicitly allocate the PUCCH transmission resource, and may explicitly allocate the PUCCH transmission resource through the upper layer signaling or the ARI.

When the HARQ ACK/NACK signal is transmitted onto the SR resource, the controller 1280 determines the positive SR situation and may perform a scheduling corresponding thereto. Further, when the SR symbol is received onto the SR resource together with the received HARQ ACK/NACK signal, the controller 1280 determines the positive SR situation and may perform a scheduling corresponding thereto. In the positive SR situation, whether the HARQ ACK/NACK signal is transmitted onto the SR resource or the HARQ ACK/NACK signal is transmitted onto the ACK/NACK resource and the SR symbol is transmitted onto the SR resource may be pre-defined between the user equipment and the base station, and may be transmitted to the user equipment from the base station through the upper layer signaling.

Further, the controller 1280 determines a setting in the case where the HARQ ACK/NACK signal is transmitted onto the SR resource in the positive SR situation, for example, the additionally allocated SR resource and the number thereof, the number of bits HARQ ACK/NACK signal transmitted per SR resource, and the like to transfer the determined setting to the user equipment.

In the aforementioned exemplary system, methods have been described based on flowcharts as a series of steps or blocks, but the methods are not limited to the order of the steps of the present invention and any step may occur in a step or an order different from or simultaneously as the aforementioned step or order. Further, it can be appreciated by those skilled in the art that steps shown in the flowcharts are not exclusive and other steps may be included or one or more steps do not influence the scope of the present invention and may be deleted.

The aforementioned embodiments include examples of various aspects. All available combinations for expressing various aspects cannot be described, but it can be recognized by those skilled in the art that other combinations can be used. Therefore, all other substitutions, modifications, and changes of the present invention that belong to the appended claims can be made.

1. A method in which a user equipment transmits hybrid automatic repeat request (HARQ) acknowledgement/negative acknowledgement (ACK/NACK) information and a scheduling request (SR), in a communication system under a carrier aggregation environment, the method comprising:
receiving an allocation of at least one SR physical uplink control channel (PUCCH) resource; and
transmitting at least one PUCCH by using at least one SR PUCCH resource,
wherein at least one PUCCH transmits the HARQ ACK/NACK information in the case of a positive SR.

2. The method of claim 1, wherein at least one SR PUCCH resource is allocated to correspond to the number of bits of the HARQ ACK/NACK information.

3. The method of claim 1, wherein the HARQ ACK/NACK information is transmitted with being allocated to each PUCCH using at least one SR PUCCH resource to correspond to the number of transmitted bits depending on a format of the PUCCH.

4. The method of claim 1, wherein the HARQ ACK/NACK information is transmitted with being allocated to each PUCCH using at least one SR PUCCH for each downlink subframe to which information as a target of ACK/NACK is transmitted or by a predetermined bit.

5. The method of claim 1, wherein when the number of bits of the HARQ ACK/NACK information is more than the number of bits which can be transmitted by the at least one SR PUCCH resource, the HARQ ACK/NACK information is transmitted through bundling to correspond to the number of transmission bits of at least one SR PUCCH resource.

6. The method of claim 1, wherein at least one SR PUCCH resource is allocated through an ACK/NACK resource indicator (ARI) or user equipment-specific higher layer signaling.

7. A method in which a base station receives hybrid automatic repeat request (HARQ) acknowledgement/negative acknowledgement (ACK/NACK) information and a scheduling request (SR), in a communication system under a carrier aggregation environment, the method comprising:
transmitting control information and data onto a physical downlink control channel (PDCCH) and a physical downlink data channel (PDSCH); and
receiving HARQ ACK/NACK information for the control information or the data on at least one physical uplink control channel (PUCCH),
wherein at least one PUCCH is a PUCCH using an SR PUCCH resource.

8. The method of claim 7, wherein the HARQ ACK/NACK information is transmitted with being allocated to each PUCCH to correspond to the number of transmitted bits depending on a format of at least one PUCCH.

9. A user equipment in a communication system under a carrier aggregation environment, the user equipment comprising:
a transceiver transceiving information; and
a controller transmitting a hybrid automatic repeat request (HARQ) acknowledgement/negative acknowledgement (ACK/NACK) information and a scheduling request (SR),
wherein the controller transmits at least one PUCCH in the same uplink subframe as an uplink subframe at the time of transmitting the SR by using at least one SR physical uplink control channel (PUCCH) resource, and
the controller transmits the HARQ ACK/NACK information on at least one PUCCH in the case of a positive SR.

10. The user equipment of claim 9, wherein at least one SR PUCCH resource is allocated to correspond to the number of bits of the HARQ ACK/NACK information.

11. The user equipment of claim 9, wherein the HARQ ACK/NACK information is transmitted with being allocated to each PUCCH using at least one SR PUCCH resource by the predetermined bit unit.

12. The user equipment of claim 9, wherein the HARQ ACK/NACK information is transmitted with being allocated to each PUCCH using at least one SR PUCCH for each downlink subframe to which information as a target of ACK/NACK is transmitted.

13. The user equipment of claim 9, wherein at least one SR PUCCH resource is allocated through an ACK/NACK resource indicator (ARI) or user equipment-specific higher layer signaling.

14. A base station in a communication system under a carrier aggregation environment, the base station comprising:
a transceiver transceiving information; and
a controller receiving a hybrid automatic repeat request (HARQ) acknowledgement/negative acknowledgement (ACK/NACK) information and a scheduling request (SR),
wherein the controller receives HARQ ACK/NACK information for data transmitted to a downlink on at least one physical uplink control channel (PUCCH), and
at least one PUCCH is a PUCCH using an SR PUCCH resource.

15. The base station of claim 14, wherein the HARQ ACK/NACK information is transmitted with being allocated to each PUCCH to correspond to the number of transmitted bits depending on a format of at least one PUCCH.
